(19) United States
(12) Patent Application Publication
(10) Pub. No.: US 2009/0205125 A1
(43) Pub. Date: Aug. 20, 2009

(54) PLASTIC BATH BAR

(76) Inventor: Earl David Forrest, Asheboro, NC (US)

Correspondence Address: Masco Corporation, 21001 Van Born Road, Taylor, MI, 48480, US

(21) Appl. No.: 12/032,837

(22) Filed: Feb. 18, 2008

(51) Int. Cl. A47K 3/00; B29C 45/14

(52) U.S. Cl. 4/576.1; 264/251

(57) ABSTRACT

This disclosure relates to a grab bar assembly that includes a bar extending along a longitudinal direction. The bar includes opposing legs extending away from a front side to a rear side and terminating in a base. The base provides a surface that seals against a wall. The bar is a non-reinforced structure having no internal metallic reinforcing members. In one example, the bar is constructed from a gas-assisted injection molding process that creates a hollow within the bar. The bar includes a gripping area on the rear side, and is over-molded with a thermo plastic elastomer in one example. A single attachment feature, such as a lag screw, is provided at each of the opposing legs to secure the grab bar to the wall. An aesthetic cover is secured to the bar to enclose the fastening element.

### BACKGROUND

This disclosure relates to a plastic bath bar or grab bar for use in a bathing area, such as a shower enclosure or near a bath tub. This disclosure also relates to a method of manufacturing the grab bar.

Bath grab bars are secured to walls shower enclosures or near bath tubs to assist a person in entering or exiting a particular area. As such, the bath bar must be capable of supporting the person's weight. For applications under the American Disability Act (ADA), the grab bar must be even more robust than non-ADA applications, since the grab bar must be capable of supporting 250 pounds without permanent deformation. To meet ADA requirements, some grab bars employ a steel or aluminum reinforcing tube about which plastic is molded. Further, grab bar assemblies employ complicated attachment structures that are time consuming to secure to the wall. This adds cost to the grab bars.

Soft material has been used over plastic bars to improve a person's grasp. However, the material has been subject to delamination and is often positioned in on the bar where it is not of much use, such as the front side of the bar.

What is needed is a grab bar that is simple and cost effective to manufacture while meeting ADA requirements. It is also desirable to provide gripping features that improves a person's grasp on the bar.

### SUMMARY

This disclosure relates to a grab bar assembly that includes a bar extending along a longitudinal direction. The bar includes opposing legs extending away from a front side to a rear side and terminating in a base. The base provides a surface that seals against a wall. The bar is a non-reinforced structure having no internal metallic reinforcing members. In one example, the bar is constructed from a gas-assisted injection molding process that creates a hollow within the bar.

The bar includes a gripping area on the rear side, and is over-molded with a thermo plastic elastomer in one example.

A single attachment feature, such as a lag screw, is provided at each of the opposing legs to secure the grab bar to the wall. An aesthetic cover is secured to the bar to enclose the fastening element.

These and other features of the disclosure can be best understood from the following specification and drawings, the following of which is a brief description.

### BRIEF DESCRIPTION OF THE DRAWINGS

FIG. 1 is an exploded perspective view of an example grab bar assembly.

FIG. 2 is a cross-sectional view of a leg of the grab bar.

FIG. 3 is a flow chart depicting an example manufacturing and installation process.

FIG. 4 is a rear perspective view of the bar prior to over-molding.

FIG. 5 is a rear perspective view of the bar shown in FIG. 4 after over-molding.

FIG. 6 is a cross-sectional view of the bar taken along line 6-6 in FIG. 5.

### DETAILED DESCRIPTION

A grab bar assembly 10 is shown in FIG. 1. The assembly 10 includes opposing front and rear sides 11, 13. The assembly 10 includes a bar 14 having opposing legs 15 that extend from the front side 11 to the rear side 13. The bar 14 extends along a longitudinal direction L. The legs 15 are secured to a wall 12 by fastening elements 30, such as ¼ inch lag screws.

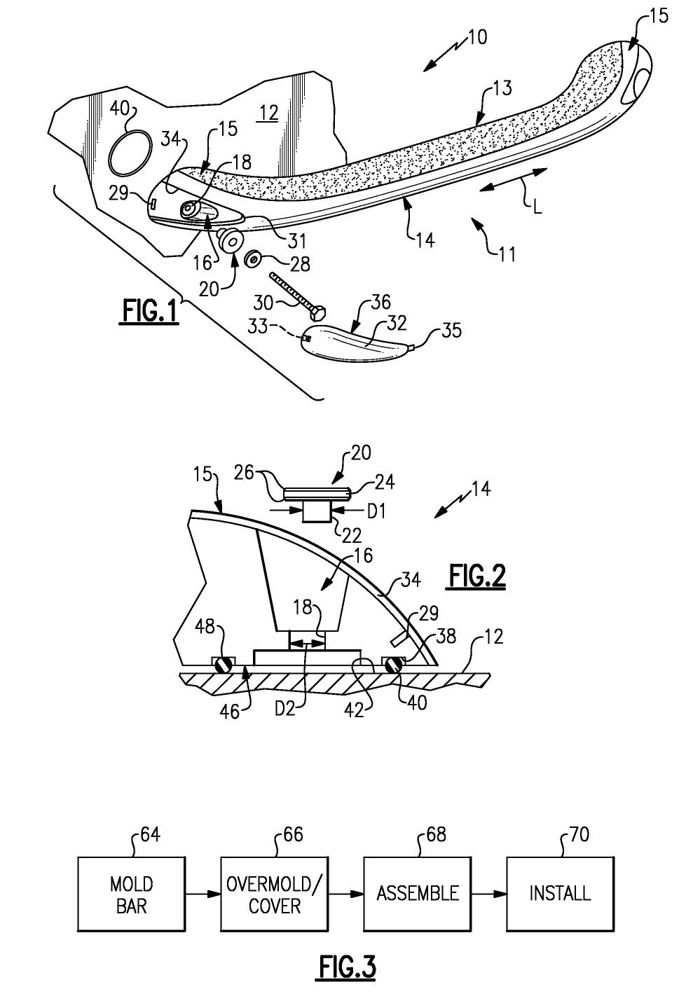

In the example, each leg 15 includes a cavity 16 that has a hole 18 for receiving the fastening element 30. In one example, an insert 20 is disposed within the cavity 16 and aligned with the hole 18 to reinforce the legs 15 so that the area does not crack during installation or use, thus, weakening the bar 14. Referring to FIG. 2, the insert 20 includes a body 22 having a diameter D1. A flange 24 extends radially outwardly from the body 22 and acts as a washer against which a head of the fastening element 30 abuts during installation. In one example, the hole 18 includes a diameter D2 that is smaller than the diameter D1. The insert 20 can be separately installed into the hole 18 in an interference fit in one example, or the bar 14 can be molded about the insert 20 when it is formed. In one example, the insert 20 is constructed from a brass material. The insert 20 includes chamfered edges 26 to prevent stress risers and cracking of the leg 15 during installation as the fastening element 30 is screwed into the wall 12.

The insert 20 is sealed relative to the bar 14, as described above. A resilient washer 28 is provided between the fastening element 30 and the insert 20 to provide a seal. In one example, the resilient washer 28 can be constructed from a nylon material.

The cavity 16 includes an edge 34. An aesthetic cover 32 is installed over the cavity 16 to enclose the fastening element 30 and provide an aesthetically pleasing appearance. The cover 32 includes a perimeter 36 that locates the cover 32 relative to the bar 14 with the perimeter 36 in abutting relationship the edge 34. In the example shown, the bar 14 includes first and second slots 29, 31. The cover 32 includes first and second tabs 33, 35 that are respectively received by the first and second slots 29, 31. In the disclosed example, the cover 32 is generally flush with the exterior surface of the front side 11 of the bar 14.

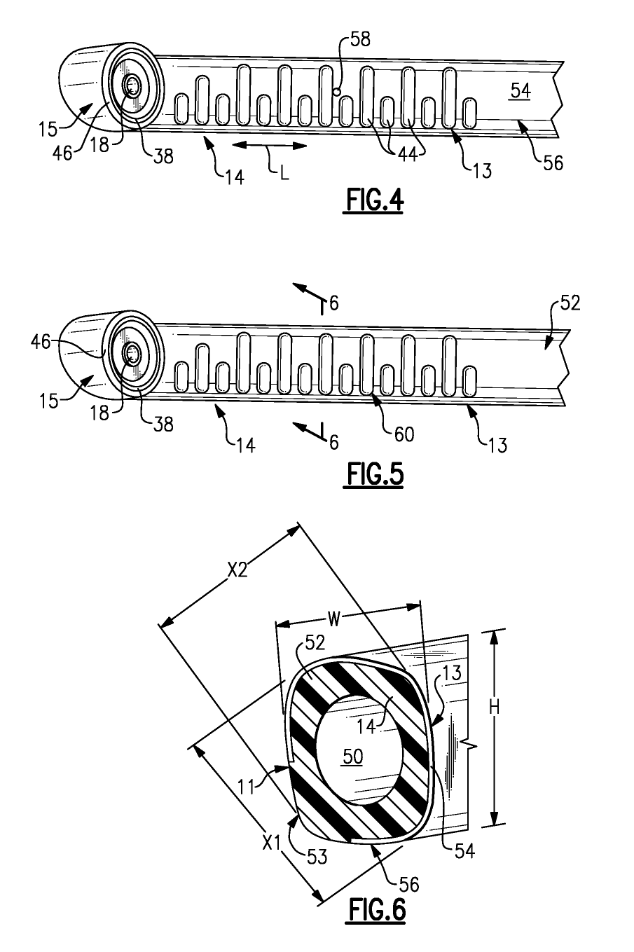

Referring to FIGS. 3-5, the bar 14 and legs 15 are molded as a single, unitary member that is formed by a molding process (block 64), such as gas-assisted injection molding. In one example, the bar 14 is constructed from a plastic material, such as polypropylene, having an approximately 30% glass filler. Polypropylene has good chemical resistance to bathroom spray cleaners, for example. The gas-assisted molding process creates a hollow 50 (FIG. 6) created by gas being injected into the bar 14 during molding through an opening 58. However, there is no metallic reinforcing tube in the bar 14 between the legs 15 as in the prior art. The opening 58 remains once the bar 14 has been molded.

Multiple grooves 44 are arranged on the rear side 13 of the bar 14 and oriented in a transverse direction (generally perpendicular in one example) to the longitudinal direction L. The grooves 44 provide an irregular surface 54 on the rear side 13 to improve a person's grip on the bar 14. A flexible covering 52, such as a silicon rubber or a thermoplastic elastomer, is over-molded (block 66, FIG. 3) onto a recessed area 56 on the rear side 13 of the bar 14, such that it is generally flush with the front side surface of the bar 14 as shown in FIG. 5. The covering 52 is thermally fused to the surface 54 bar 14 and provides a soft touch, improved gripping area 60. The covering 52 is indented at the grooves 44.

The bar 14 includes a generally trapezoidal shape to provide a cross-section that is easier for a person to grip. As shown in FIG. 6, a height H is greater than a width W. The bar includes corners having large radii 53. A length X1 between opposing radii 53 is greater than a length X2 between another set of opposing radii. In the example shown, X1 is greater than H, and X2 is greater than W and less than H.

Each of the legs 15 includes a generally planar base 46 or surface having an annular recess 38. A seal 40, such as an o-ring, is received by the recess 38. The seal 40 can have a circular, quadrangular or other cross-sectional shape. An adhesive 48 can be used to securely retain the seal 40 within the recess 38. The seal 40 surrounds the hole 18 to prevent water from migrating past the seal 40 into the wall 12.

Referring to FIG. 3, the bar 14 can be assembled (block 68) with the seal 40 and insert 20 retained relative to the bar 14. Referring to block 70, a single fastening element 30 is used to secure each leg 15 of the bar 14 to the wall 12 in the example. A flexible washer 28 is used between the head of the fastening element 30 and the insert 20. The cover 32 is arranged over the cavity 16 to complete assembly of the bar 14.

Although example embodiments have been disclosed, a worker of ordinary skill in this art would recognize that certain modifications would come within the scope of the claims. For that reason, the following claims should be studied to determine their true scope and content.

What is claimed is:

1. A grab bar for use in a bathing area comprising:
a bar extending in a longitudinal direction between legs that are arranged transverse to the bar, each leg including a hole extending from a front side to a base that is configured to be mounted against a surface, the bar and legs are a unitary molded member wherein the bar is plastic and without metallic reinforcement between the legs.

2. The grab bar according to claim 1, wherein the bar includes a generally trapezoidal cross-section with rounded corners.

3. The grab bar according to claim 1, wherein the bar includes multiple grooves on a back side opposite the front side that are oriented transverse to the longitudinal direction, the grooves providing a gripping area.

4. The grab bar according to claim 3, comprising a flexible covering provided over the gripping area on the back side, the covering indented at the grooves.

5. The grab bar according to claim 4, wherein the bar is a glass-filled plastic and the covering is a thermoplastic elastomer.

6. The grab bar according to claim 1, wherein the bar is hollow in the longitudinal direction without metallic reinforcement in the hollow.

7. The grab bar according to claim 6, wherein a metallic insert is provided in each hole, the inserts are arranged outside of the bar and within the legs.

8. The grab bar according to claim 7, comprising a fastener arranged within each hole through the insert and extending from the front side to the base.

9. The grab bar according to claim 1, comprising a fastener extending through each hole from the front side to the base and configured to secure the legs to the surface.

10. The grab bar according to claim 9, wherein each leg only includes one fastener.

11. The grab bar according to claim 9, comprising a cover secured to the leg and enclosing the fastener.

12. A grab bar for use in a bathing area comprising:
a bar extending in a longitudinal direction between legs that are arranged transverse to the bar, each leg including a hole extending from a front side to a base that is configured to be mounted against a surface, the bar including multiple grooves on a back side opposite the front side, the grooves providing a gripping area; and
a flexible covering provided over the gripping area on the back side, the covering indented at the grooves.

13. The grab bar according to claim 12, wherein the bar is a glass-filled plastic and the covering is a thermoplastic elastomer.

14. The grab bar according to claim 12, wherein the bar is plastic and without metallic reinforcement between the legs.

15. The grab bar according to claim 12, wherein the bar includes a generally trapezoidal cross-section with rounded corners.

16. The grab bar according to claim 12, wherein the bar includes a surface adjacent to a recessed area, the recessed area including the grooves transverse to the longitudinal direction, the covering adhered over the recessed area and generally flush with the surface.

17. The grab bar according to claim 16, wherein the bar is hollow in the longitudinal direction without metallic reinforcement in the hollow, and an opening in the bar extending from the covering to the hollow.

18. The grab bar according to claim 12, wherein the bar includes a circumference, and the covering wraps about the bar less than the circumference leaving a gap with the bar exposed on the front side.

19. A method of manufacturing a grab bar for use in a bathing area comprising the steps of:
a) injection molding from a plastic a longitudinally extending bar and adjacent spaced apart legs transverse from the bar, the bar having a longitudinally extending hollow; and
b) over-molding a flexible covering over the bar.

20. The method according to claim 19, wherein step a) includes molding the bar without a metallic reinforcement in the hollow between the legs.
